(19) United States
(12) Patent Application Publication
(10) Pub. No.: US 2022/0410925 A1
(43) Pub. Date: Dec. 29, 2022

(54) Coordinated Virtual Scenes for an Autonomous Vehicle

(71) Applicant: AT&T Intellectual Property I, L.P., Atlanta, GA (US)

(72) Inventor: Satya Vardharajan, San Diego, CA (US)

(21) Appl. No.: 17/357,814

(22) Filed: Jun. 24, 2021

(51) Int. Cl. B60W 60/00; G01C 21/34

(52) U.S. Cl. CPC B60W 60/001; G01C 21/3415; B60W 2554/4045; B60W 2554/4049; B60W 2540/01

(57) ABSTRACT

A coordinated virtual scene for an autonomous vehicle is disclosed. A real route for an autonomous vehicle can be determined. This autonomous vehicle route can be employed to determine a virtualized route in a virtual environment. The autonomous and virtualized routes can be coordinated. A level of coordination can be selectable via one or more selectable congruence values. Generally, a greater congruence value can correspond to a greater coherence between the autonomous route and the virtualized route. A congruence value can be selectable, which can allow an occupant to indicate a level of coherence that is acceptable to an occupant. A virtual environment can be selectable to enable the virtualized routes to be more relevant to an autonomous vehicle occupant, passenger, operator, etc. Moreover, selection of a virtual environment can be predicated on a selection rule having been satisfied. Virtual environments can be non-fiction, fiction, or both.

### BACKGROUND

Conventionally, vehicle users, e.g., drivers, pilots, captains, etc. need to be aware of conditions surrounding them as they operate a vehicle, e.g., driving to a destination, flying a plane, navigating a ship, etc. An occupant's attention can be needed to aid in negotiating traffic, avoiding, obstacles, staying on a designated track, etc., and to improve the likelihood that the occupant and vehicle, along with passengers, cargo, etc., safely reach a destination. Focusing occupant attention on vehicle/environment conditions can be needed even where such focus can be difficult, stressful, etc.

### BRIEF DESCRIPTION OF DRAWINGS

FIG. 1 is an illustration of an example system that can enable rendering a coordinated virtual scene for an autonomous vehicle, in accordance with aspects of the subject disclosure.

FIG. 2 is an illustration of an example system that can facilitate rendering a coordinated virtual scene for an autonomous vehicle according to a selectable level of congruence, in accordance with aspects of the subject disclosure.

FIG. 3 is an illustration of an example system that can enable rendering coordinated virtual scenes for autonomous vehicles, in accordance with aspects of the subject disclosure.

FIG. 4 illustrates an example system that can facilitate rendering a coordinated virtual scene that can be responsive to changes to an autonomous vehicle route, in accordance with aspects of the subject disclosure.

FIG. 5 is an illustration of an example system enabling rendering a coordinated virtual scene in a manner that is in response to a selected congruence value, in accordance with aspects of the subject disclosure.

FIG. 6 is an illustration of an example system enabling rendering a coordinated virtual scene comprising assorted rendered sensory content, in accordance with aspects of the subject disclosure.

FIG. 7 illustrates an example method facilitating rendering of a coordinated virtual scene for an autonomous vehicle, in accordance with aspects of the subject disclosure.

FIG. 8 illustrates an example method enabling rendering of a coordinated virtual scene based on a selectable congruence value, in accordance with aspects of the subject disclosure.

FIG. 9 depicts an example schematic block diagram of a computing environment with which the disclosed subject matter can interact.

FIG. 10 illustrates an example block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As has been noted for conventional vehicles, occupants can be required to maintain awareness of conditions corresponding to operation of the vehicle, e.g., driving to a destination, flying a plane, navigating a ship, etc. An occupant's attention can be needed to aid in negotiating traffic, avoiding, obstacles, staying on a designated track, etc., and to improve the likelihood that the occupant and vehicle, along with passengers, cargo, etc., safely reach a destination. Focusing occupant attention on vehicle/environment conditions can be needed even where such focus can be difficult, stressful, etc. However, with the impending advent of autonomous vehicles, an occupant can be freed from the stress of near persistent focus on operating conditions. As such, an occupant can be allowed to choose an alternate experience while travelling because they may no longer be required to be as highly focused where the autonomous vehicle can largely navigate the vehicle, although an occupant can be called on to act quickly and appropriately where an autonomous vehicle experiences an inability to manage a given operating condition of the vehicle, e.g., hardware/software faults, poorly modeled responses to unusual conditions, etc.

In embodiments of the disclosed subject matter, a vehicle occupant, e.g., a first occupant, a second occupant, a passenger(s), etc., hereinafter collectively an ‘occupant’ unless inherently or explicitly referring to a particular occupant, passenger, etc., can be freed from the typical levels of attention associated with being conveyed between locations via a vehicle. Where an occupant can devote less attention to autonomous vehicular transport than to conventional vehicular transport, the occupant can be allowed to be attentive to other experiences. In an example embodiment of the disclosed subject matter, an occupant can be presented with a scene, more particularly a virtual scene rendered from virtual route information. As an example, a drive from point A to point B can be primarily through a stretch of blighted urban landscape. In this example, a virtualized route can be determined from a virtual tropical island environment. The routing information for the drive between points A and B can be employed in determining the virtualized route, e.g., the turns, accelerations, time, and directionality of the real route through urban blight can be translated into a virtualized route emulating those features of the real route. Accordingly, virtualized route information for the determined example virtualized route can be employed to render a virtual scene for the vehicle occupant, which can allow the occupant to experience a tropical island drive, albeit virtually, during the actual drive from point A to point B through the blighted urban region. This can provide a more pleasant experience for the occupant.

Conventional technology to present a vehicle occupant with a virtual environment, e.g., a flight simulator, video game system, etc., can be leveraged to provide for the novel disclosed subject matter than can take an automated route as input to determine a virtualized route which can be augmented in response to other real-world inputs, for example, delays, detours, changing weather, emergent conditions, etc., that were not indicated in autonomous vehicle route information. As such, unlike a flight simulator that relies on input from a pilot in rendering a scene, an embodiment of the disclosed subject matter can determine virtualized route information enabling rendering of virtual scenes without any in-progress input from the occupant. Moreover, where the real-world environment changes, for example another vehicle having a flat tire that causes automatic rerouting of the autonomous vehicle, etc., the virtualized route information can be correspondingly updated, which can also occur without occupant input. Further, unlike a simulator that seeks to emulate a physical environment without the occupant experiencing actual travel between a starting location and a destination location, e.g., a simulator is typically static while providing a simulated non-static experience, the disclosed subject matter can be non-static while also providing a non-static experience, e.g., the vehicle can transport the occupant while the occupant experiences a virtual environment that can be based on the actual physical transport of the autonomous vehicle.

Furthermore, the disclosed subject matter can provide for selection of a virtual environment. Selection of a virtual environment can enable an autonomous vehicle occupant to pick a preferred virtual experience. As an example, an autonomous vehicle route through urban blight from point A to B can also be emulated in a virtual environment. In this example, an occupant can be presented with rendered virtual scenes that can directly mirror the actual physical transport, e.g., the virtual experience can, turn-for-turn, match the real transport. This example however provides the occupant with little apparent benefit. As such, the occupant can select a different virtual environment, for example the aforementioned tropical island virtual environment, which can enable presenting the occupant with virtual scenes of driving along a sunny beach. In some embodiments, the virtual beach drive example can be matched against the turns, accelerations, directionality, etc., of the physical drive between points A and B. However, in some embodiments, a selectable level of congruence between the real-world transport environmental conditions and virtualized route information can result in the real-world route and the virtual route diverging correspondingly. As an example, a selected first level of congruence can correspond to closely matching changes in the autonomous vehicle route to changes in the virtualized route, e.g., if the vehicle turns in real life, the virtual scene rendering can emulate a matching turn. As another example, a second selected level of congruence can allow high divergence between the autonomous vehicle route and the virtualized route, e.g., if the vehicle turns in real life, the virtual scene rendering does not need to emulate that real-world turn, although this example low-congruence example can result in the occupant feeling movement that does not match the rendered scene of the virtualized route. The use of selectable congruence(s) can facilitate a virtualized scene by de-emphasizing the correlation between the real and the virtual experience of an occupant. In some conditions this divergence between the real and virtual routes can be nearly imperceptible to an occupant, for example where a real route comprises a long shallow curve that is less perceptible to an occupant, a selected congruence level can facilitate letting a straight virtual path be presented. In another example, a long slow virtual turn can be rendered for a relatively straight portion of real-world travel because the occupant can select a level of congruence between the real and virtual than meets their level of motion perception and tolerance for discord between a rendered scene and an experienced physical change while traversing autonomous vehicle route. Congruence value(s) selection can relate to one or more of nearly any environmental variable, e.g., levels of acceleration/deceleration, change in direction or other inertial moment(s), temperature, climate, solar radiation and shadow, aural landscape, olfactory landscape, etc.

In an embodiment, the virtual environment can be based on, at nearly any level of accuracy, a real-world environment. As an example, this can enable an autonomous aircraft flying between Chicago and London to present an occupant, e.g., the pilot, passengers, flight attendants, etc., with a virtualized route emulating traversing an underwater ‘Jules Verne-type’ virtual submarine vehicle experience that can still be based on the autonomous route, e.g., length of the trip, changes in inertia the human body feels in the flight, occurrences of turbulence can be incorporated into the rendered scenes in real time, etc. Moreover, some embodiments can employ virtual environments that are fictional, for example, being based on a science fiction movie, fictional book, etc. In an example of this, an automated taxi ride can present a fare with rendered scenes of traversing an artist's rendition of the hanging gardens of Babylon, riding a shuttlecraft next to a pointy-eared and highly logical alien, operating a robot on a verdant planet populated by large blue aliens with interesting tails, etc. Other virtual environments can also enable time-shifting, e.g., a virtual environment can render scenes that can be based on the example taxi ride but can set the taxi ride in 1895 New York City. In this example, the rendering can also be selected to be colorized, or more fancifully, in black and white, e.g., as in would be seen in archival film footage. Moreover, where an autonomous vehicle can transport multiple people, e.g., an first occupant and a second occupant, etc., the disclosed subject matter can present each occupant of the vehicle with a virtualized route that can be the same or different virtualized routes, e.g., a first occupant can be virtually transported through medieval Paris while a second occupant can be virtually transported between two Martian bases, wherein both virtualized routes can be based on the autonomous vehicle route, selected level(s) of congruence for each of the occupants to their respective virtualized route, etc.

Beneficially, the disclosed subject matter can further enable occupants to support development of virtual environments, e.g., virtual environments can be developed in a pay-to-access system. This can provide monetization that can result in competition to provide higher quality virtual environments. Moreover, a virtual environment can include sharing of routing information that can support ‘group transport,’ e.g., rendered scenes can include emulations of other occupants. As an example, a first occupant autonomously driving from Seattle to Sacramento can experience a virtualized environment emulating flying through the Swiss Alps. Further, in this example, a second occupant can be autonomously flying from Rome to Cape Town and can indicate that they would like to share the virtual environment with the first occupant. As such, in this example, the first and second occupants, or avatars thereof, can be visible to each other in rendered scenes from a corresponding virtualized route according to the shared virtual environment. By adjusting the corresponding congruence levels in this example, the speed of the first occupant driving and the speed of the second occupant flying can each be set to a similar speed in the virtual shared environment. Similarly, in accord with a selected congruence value, detours of the first autonomous vehicle route can be compensated for in the shared virtual environment. Accordingly, in this example, distant occupants can share a journey via the virtual environment. Other benefits of the presented coordinated virtual scenes for autonomous vehicle(s), can be readily appreciated and are to be considered within the scope of the instant disclosure despite not being explicitly recited for the sake of clarity and brevity.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

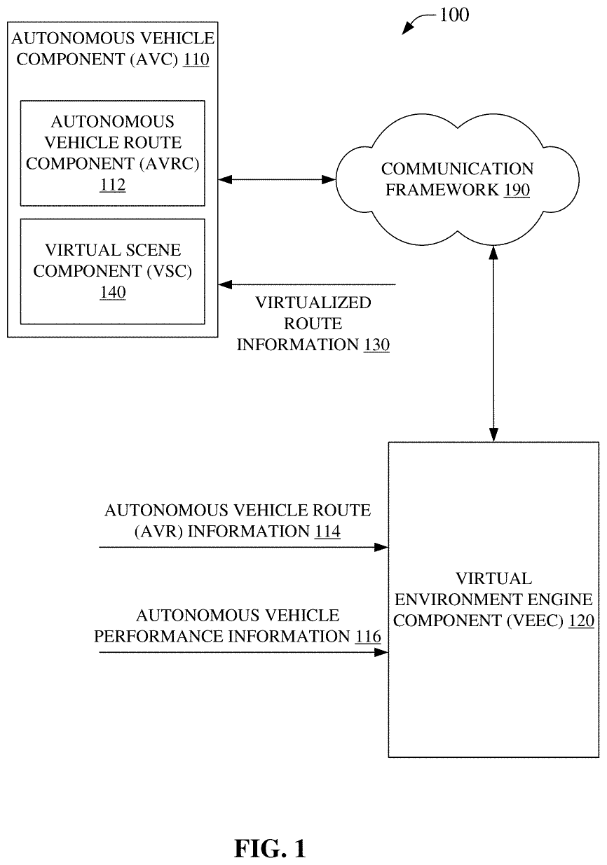

FIG. 1 is an illustration of a system 100, which can facilitate rendering a coordinated virtual scene for an autonomous vehicle, in accordance with aspects of the subject disclosure. System 100 can comprise autonomous vehicle component (AVC) 110. AVC 110 can be comprised in, correspond to, be connected with, etc., any autonomous vehicle, e.g., car, train, boat, ship, spacecraft, submarine, or other form of autonomous transportation. As an example, AVC 110 can be embodied in an autonomous car, e.g., a self-driving car. An autonomous vehicle can determine a route for navigating the autonomous vehicle, e.g., given a starting point and an ending point, an autonomous vehicle can determine a route that can enable the autonomous vehicle to travel between the starting point and the ending point, typically without input from an occupant of the autonomous vehicle. In some circumstances an autonomous vehicle can receive occupant input, however such occasional occupant input does not cause the autonomous vehicle to depart from the scope of the disclosed subject matter. Generally, the term occupant applies to a person operating an example autonomous vehicle, however, the term is generally used inclusively to indicate any occupant of the vehicle, e.g., first occupant, second occupant, etc., for the sake of brevity.

AVC 110 can comprise an autonomous vehicle route component (AVRC) 112 that can facilitate access to autonomous vehicle route (AVR) information, e.g., AVR information 114, etc. AVR information can indicate automated vehicle parameters supporting traversing a route between a first location and a second location by an autonomous vehicle. As an example, AVR information can comprise a route, an alternate route, traffic information, weather information, starting location, ending location, mapping information, waypoints, speed limit information, construction information, an occupant input, such as a preferred route, intermediate points, etc., among other inputs, that can enable an example autonomous vehicle to travel between a first and second location, typically without intervention by an autonomous vehicle occupant. Examples of autonomous vehicle route information can comprise level 4, level 5, etc., self-driving cars, etc. Generally, a level 4 vehicles can respond to errors, system failures, etc., and generally do not require human interaction, although a human can still manually override a level 4 autonomous vehicle. Similarly, a level 5 vehicle does not require human attention and “human driving” is typically considered eliminated in a level 5 vehicle. A level 5 vehicle may even lack a conventional human interface, e.g., a level 5 car can have no steering wheel, accelerator pedal, brake pedal, gear selector, etc. Often, a level 5 vehicle is not geofenced and can go anywhere and can do anything typically associated with what an experienced human occupant can do. These can be considered ‘fully autonomous vehicles’ that are anticipated as becoming publicly available in the near future. The disclosed subject matter is expressly not strictly limited to ‘level 4’ or ‘level 5’ autonomous vehicles as the disclosed subject matter can be implemented outside of these current definitions of an autonomous vehicle. Accordingly, AVRC 112 of AVC 110 can facilitate access to AVR information 114, for example by virtual environmental engine component (VEEC) 120 via communication framework 190, which can be the same as, or similar to, communication framework 990, etc., whereby AVR information 114 can indicate real-world route information for an autonomous vehicle to VEEC 120 to facilitate determining a corresponding virtualized route. In embodiments, VEEC 120 can be comprised in AVC 110, local to AVC 110, or remotely from AVC 110. As an example, VEEC 120 can be comprised in a network component of a network provider, wherein the autonomous vehicle can communicate via communication framework 190 with the example VEEC 120 of the network provider.

VEEC 120 can be communicatively coupled to other components of system 100, e.g., via communication framework 190, by other direct or indirect communication links not illustrated for the sake of clarity and brevity, etc. VEEC 120 can determine a virtual route. In an embodiment, the virtual route can correspond to a real-world route of an autonomous vehicle. As an example, a self-driving car can determine AVR information 114 that can enable the self-driving car to drive one mile in a straight line through a desert. In this example, VEEC 120 can receive AVR information 114 and can determine a virtual route based on AVR information 114, for example where a virtual environment is artic-themed, driving one mile in a straight line across an ice shelf. This virtual route can comprise virtual scenes that can be rendered based on virtualized route information 130 that can correspond to the determined virtual route. As such, in this example, virtualized route information 130 can be accessed by AVC 110, e.g., via communication framework 190 from VEEC 120, etc., which can enable virtual scene component (VSC) 140 to render a scene of the corresponding example virtual route. In this example, as the autonomous vehicle travels the one mile through the desert in accord with AVR information 114, virtual route scene(s) can be rendered by VSC 140 to facilitate presenting an occupant of the autonomous vehicle with an experience emulating driving along an ice shelf in the artic. In an embodiment, VSC 140 can be comprised in AVC 110, local to AVC 110, or remotely from AVC 110, for example, VSC 140 can be performed on a remote server and a rendered scene to be displayed in the autonomous vehicle can be communicated to AVC 110 via communication framework 190, etc. The emulation presented via rendered scenes can be based on AVR information 114 and can therefore mirror characteristics of the real-world desert driving in the virtualized arctic driving scenes, e.g., the rendered arctic scenes can be based on the acceleration of the real-world vehicle previously communicated via AVR information 114. Similarly, for example, where the example path comprises a turn, this predetermined turn can be communicated via AVR information 114 such that virtualized route information 130 can simulate the same turn at the same time and under the ‘same conditions,’ e.g., inertial predictions, environmental considerations such as the angle of the ground at the time of the turn, etc. In this example, if the autonomous vehicle is pointed downhill at the time of the turn, then the virtualized route can also simulate the car pointing downhill. However, in some circumstances, for example where a selected congruence level allows less coherence between the real-world traversal and the virtual traversal, the car may not point downhill, may point downhill more steeply, less steeply, etc., although congruence is discussed in more detail elsewhere herein.

AVC 110 can further facilitate access to autonomous vehicle performance information 116. Autonomous vehicle performance information 116 can be employed by VEEC 120 to update virtualized route information 130. In an example, autonomous vehicle performance information 116 can indicate that an autonomous vehicle, for example a self-flying plane, is departing from the vehicle route embodied in AVR information 114, for example, where the self-flying plane diverts to a different altitude to avoid unexpected air turbulence. Autonomous vehicle performance information 116, in this example, can indicate a change in pitch, roll, yaw, acceleration, altitude, and inertial changes resulting from buffering of the aircraft by turbulence, etc. This additional recent autonomous vehicle performance information can enable VEEC 120 to meaningfully update virtualized route information 130 being accessed by a VSC 140 comprised in the self-flying plane. This can enable rendering a scene that better corresponds to the change in elevation and the rough skies than would be presented to an occupant in the absence of the example autonomous vehicle performance information 116.

In a similar example, a self-driving car can get stuck behind another vehicle that gets an unexpected flat tire causing the car to depart from the planned real-world route. In this example, where the self-driving car is stopped in traffic from the other car's flat tire, an occupant of the self-driving car can be expected to feel that the car is stopped which can be incongruous with rendering a virtual scene emulating the vehicle continuing to move. In this example, autonomous vehicle performance information 116 can indicate the slowing and then stopping of the self-driving car to enable VEEC 120 to update virtualized route information 130, such that rendered scenes via VSC 140 can better correspond to the self-driving car slowing and then stopping, for example, the rendered virtual environment can emulate slowing and stopping, or alternatively, the virtual scene can be rendered to emulate slowing then virtually accelerating slowly enough that the occupant would not expect to ‘feel’ the internal change corresponding to the virtual acceleration, which trick can result in the occupant believing that they are still traversing the route even though they can physically be at a stop.

It is noted that the level of human perception for inertial changes can be leveraged by VEEC 120 to present a virtual route that can correspond less to a real-world route while still appearing to be acceptable to an occupant. In embodiments, the level of occupant satisfaction with rendered scenes ‘feeling correct’ for real-world inertia, environment, etc., can be reflected in one or more congruence settings, e.g., congruence can be reduced to allow less strict correspondence between a virtual route and a real-world route where the occupant's perception is still satisfactorily met, where the occupant accepts that the perception is not perfectly aligned with physical sensations, etc. As an example, a virtual route along a high cliff with sheer drops to either side can be nearly impossible to reconcile with the physical real-world sensation of an autonomous vehicle taking emergency evasive action to avoid hitting an animal that jumped into a roadway. In less extreme examples, a detour due to traffic conditions can be compensated for virtually based on a congruence setting, e.g., with congruence set to tightly correlate, the real-world detour can occur far enough in the future to allow the virtual cliff route to transition to a rendered scene enabling the detour to match the rendered scene, e.g., coming off the cliff to an area that the car can turn left in both the real-world and the virtual route. Alternatively, where congruence is set to allow for low congruence between the real and virtual routes, the real-world detour can result in the virtual route appearing to have the vehicle operating in thin air away from the cliff top route which, while physically impossible, can be acceptable to the occupant in the rendered virtual route scene.

In embodiments, rendering a scene can comprise presenting an occupant with input corresponding to the scene. As such, the rendering can be visual, auditory, olfactory, tactile, inertial, positional, etc. As an example, actuators can be attached to an occupant chair within an autonomous vehicle. These example actuators can provide degrees of freedom in conjunction with the physical motion, position, etc., of the autonomous vehicle, e.g., the actuators can simulate a bumpy road even where the real-world vehicle is on smooth pavement, can provide a sensation yaw/roll/pitch even where the vehicle experiences different yaw/roll/pitch, can provide damping of vehicle real-world movement to better match a virtual environment route, etc. Visual scene renders can be presented via portals of a vehicle, e.g., replacing windows with displays, etc., via wearables, e.g., a virtual reality headset worn by an occupant, etc., via an implantable human interface component, e.g., an in-situ device that can interact with an occupant's optic nerve, vision (or other) centers in the occupant brain, etc. Similarly, olfactory renders can release odors/chemicals into the vehicle cabin, can stimulate the occupant brain or olfactory nerves, etc. The details of how a virtualized route scene is rendered, while related to the disclosed subject matter, is generally considered to be tangential to the instant disclosure and is therefore not discussed in more detail herein for the sake of clarity and brevity, although all such germane techniques are considered within the scope of the instant disclosure.

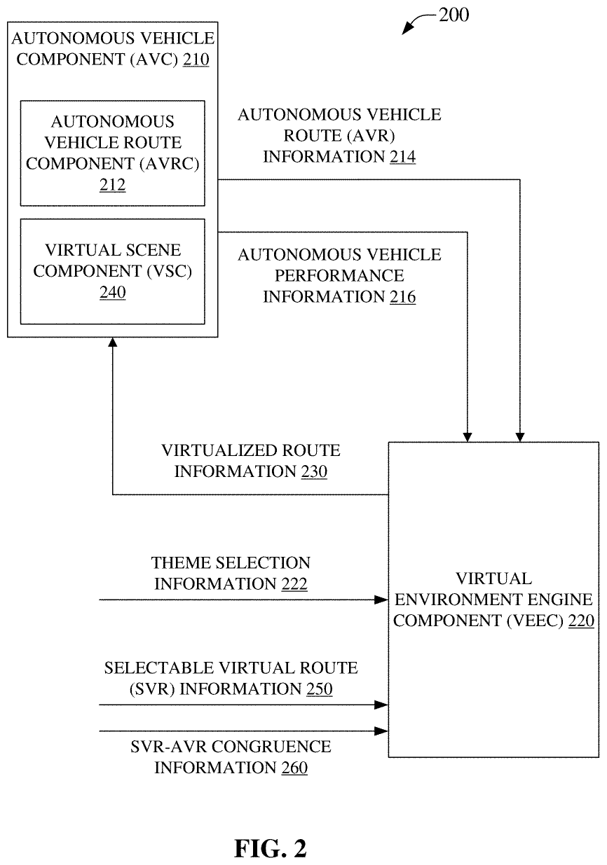

FIG. 2 is an illustration of a system 200, which can enable rendering a coordinated virtual scene for an autonomous vehicle according to a selectable level of congruence, in accordance with aspects of the subject disclosure. System 200 can comprise AVC 210. AVC 210 can determine a route for navigating an autonomous vehicle between two or more points. AVC 210 can comprise AVRC 212 that can facilitate access to AVR information 214, etc. AVR information can indicate automated vehicle parameters corresponding to the vehicle traversing a route. Accordingly, VEEC 220 can access AVR information 214 via AVRC 212 of AVC 210, e.g., via communication framework 190, 990, etc., or via other communicative couplings. AVR information 214 can indicate real-world route information for an autonomous vehicle to VEEC 220 to facilitate determining a corresponding virtualized route that can correspond to virtualized route information 230.

In an embodiment, a virtual route can correspond to a real-world route of an autonomous vehicle. As an example, a self-driving car can determine AVR information 214 that can enable the self-driving car to navigate between an occupant's home and office. In this example, VEEC 220 can receive AVR information 214 and can determine a virtual route based on AVR information 214. In an embodiment, VEEC 220 can provide a virtual environment based on theme selection information 222. Theme selection information 222 can therefore enable selection of a virtual environment in which a virtualized environment will be determined. As an example, theme selection information 222 can indicate selection of a terrestrial virtual environment, an oceanic virtual environment, an extra-planetary virtual environment, an arial virtual environment, a fictional virtual environment, etc. Theme selection information 222, in an embodiment, can be indicated by an autonomous vehicle occupant, e.g., a first occupant, second occupant, etc. Different virtual environments can be selected for combination with AVR information 214 at VEEC 220. In an example, a historically accurate historical city virtual environment can be selected via theme selection information 222 that can result in virtualized route information 230 facilitating a virtual route through a historically accurate rendering of a Tokyo, for example. As another example, theme selection information 222 can result in selection of a virtual environment emulating a dystopian future world that can result in virtualized route information 230 facilitating a virtual route through a barren desert filled with marauding bands. In an embodiment, selection of an environment can be predicated on determining that a selection rule has been satisfied. As an example, a violent environment, such as the beaches of Normandy on D-Day, can be restricted to mature audiences, e.g., can carry an “R-rating,” to restrict access to the environment. As another example, a governmental imposed rule can prevent access to an emulation of a region that can cast that region in a poor light, e.g., inaccurate representations of real environments can be restricted. This can, for example, prevent showing virtual country X as filled with slave laborers, country Y as being idyllic, etc., when such virtual environment can violate legal restrictions, etc. Moreover, some environments can be selected only when a payment/fee rule has been determined to be satisfied, e.g., paid environments. Paid environments can encourage competition to develop high quality virtual environments.

Additional to theme selection information 222, a virtual route can be selected, e.g., via selectable virtual route (SVR) information 250. SVR information 250 can enable selection of certain routes, or routes comprising designated features, within a virtual environment theme. As an example, theme selection information 222 can enable VEEC 220 to select and emulate historic Jerusalem, while SVR information 250 can indicate that an AVR can correlate to a selected route within this example's historic Jerusalem, such as following the Via Dolorosa. Accordingly, the real-world route of the autonomous vehicle, the Via Dolorosa, and the emulation of historic Jerusalem can be employed by VEEC 220 to synthesize virtualized route information 230 that can be employed to render scenes via virtual scene component (VSC) 240 to facilitate the occupant experiencing a simulation of traversing a historic rendition of the Via Dolorosa that is coordinated with the physical conditions of the autonomous vehicle according to a designated level of congruence, which can be indicated via SVR-AVR congruence information 260. In an example of a first congruence value, a real route through Denver can closely relate to a virtualized route of the Via Dolorosa even though it may not accurately map the historical Via Dolorosa to the ride through Denver, e.g., the rendered virtual scenes can defer to the physical movement of the vehicle rather than the historical accuracy of the Via Dolorosa. In this example, the coordination between the actual historical route of the Via Dolorosa can be less strongly coupled to the actual physical movement of the vehicle in the real world resulting in the rendered scene being less accurate in the context of the Via Dolorosa in order to allow the real route to correspond, at the selected level of congruence, more strongly to the determined virtual route. However, in another example with a second congruence value, the historical Via Dolorosa route can be indicated, for example by highlighting in the virtual environment, etc., even where the perspective of the rendered scenes still tracks the actual movement of the vehicle in the real-world. In a further example of a third congruence value being selected, there can be minimal coherence between the virtual and real worlds, a simulation that appears to accurately following the historical Via Dolorosa route can be indicated even where a rendered virtual route scene can have portions that are not in accord with the actual movement of the vehicle in the real-world, e.g., a left turn of the vehicle may not coordinate with a turn on the rendered Via Dolorosa route, which can cause the occupant to experience the discord, thereby feeling the turn even where a visual rendering does not turn, turns a different amount, turns a different direction, etc. As is noted elsewhere herein, SVR-AVR congruence information 260 can enable selection of a congruence according to an occupant input. In the above Via Dolorosa examples, the occupant can therefore select a congruence that can present a more accurate rendering of the Via Dolorosa in the virtualized route at the expense of experiencing possibly reduced coordination with an autonomous vehicle route in the physical world. However, in the Via Dolorosa examples, an occupant can also select other congruences that can, for example, sacrifice historical accuracy to better coordinate the rendered experience with the real-world vehicle route.

The use of congruence can additionally be beneficial, in some embodiments, to occupants that can have particular physical conditions, e.g., occupants that can suffer motion sickness, etc. In this embodiment, an occupant can select, via SVR-AVR congruence information 260, a level of congruence that can tightly coordinate renderings of scenes of the virtual environment with movement of the autonomous vehicle in the physical world. As such, for example, the occupant can see and feel a turn, acceleration, deceleration, etc., in a manner that coincides. This can be more comfortable to an occupant, even at the expense of not following a selected route with a high level of accuracy, e.g., a route indicated via SVR information 250, etc. It is further noted that some environments selected via theme selection information 222 and routes selected therein, via SVR information 250, can still be highly coordinated and highly accurate. As an example, a level of congruence that can tightly coordinate renderings of scenes of the virtual environment with movement of the autonomous vehicle in the physical world can be selected within an outer space theme that can more easily accommodate accurately following a selected route to coordinate with the physical route of the autonomous vehicle. In part this can be because the selected route can be entirely fictitious in some example embodiments, resulting in any virtual route being accurate to the selected route. In an example embodiment, a virtual route between the Sea of Tranquility and the Tycho crater can be coordinated with an autonomous vehicle route between Boston and Key West, e.g., the speed on the virtual lunar surface will appear much faster than the actual speed of the autonomous vehicle, but otherwise, even with a high level of congruence to, for example, forestall motion sickness due to poor coordination between visual renderings and the actual physical motion of the vehicle, the coordination can be via selection of a route elements that support the anticipated turns, slopes, traffic, etc., of the example earthbound vehicle. In this example, the virtual route is ‘given a degree of poetic license’ to allow the virtual route to tightly correspond to the real-world route while still appearing to traverse between the Sea of Tranquility and the Tycho crater. It is further noted that autonomous vehicle routes and corresponding virtualized routes can be paused, restarted, reused, broken into stages, etc., for example to enable a themed multi-day trip that might pause for a night in a hotel and then resume the virtualized route the following morning. As another example, a regular drive can reuse a previously selectable virtual route, such as using a virtual beach drive on the way into work every morning and using virtual fantasy drive with dragons and monsters for evening drives home.

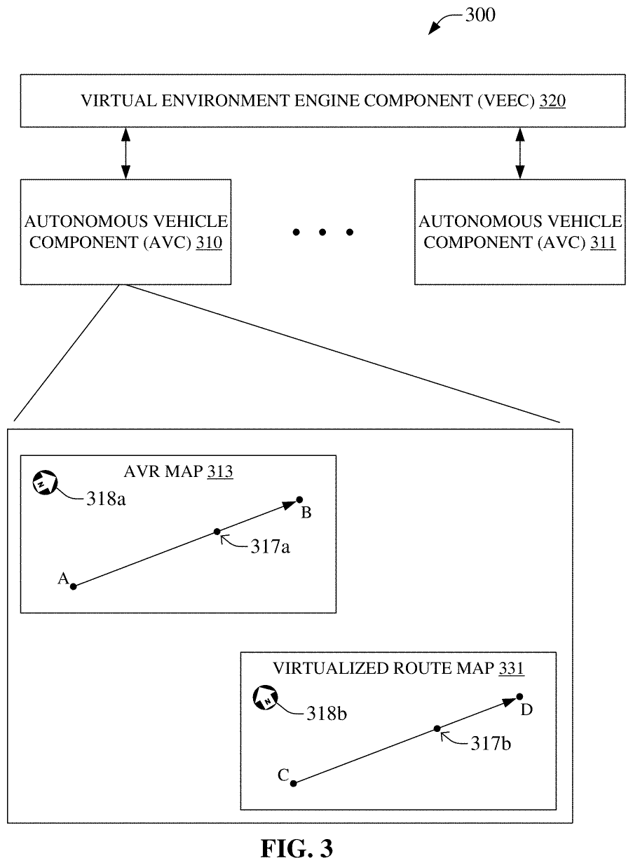

FIG. 3 is an illustration of a system 300 that can facilitate rendering coordinated virtual scenes for autonomous vehicles, in accordance with aspects of the subject disclosure. System 300 can comprise one or more AVCs, e.g., AVC 310 through AVC 311, etc. The AVCs can be communicatively coupled to VEEC 320 to facilitate coordinating virtual scenes with an autonomous vehicle route. AVC 310, 311, etc., can determine a route for navigating an autonomous vehicle between two or more points and can facilitate access to AVR information. AVR information, e.g., AVR information 114, 214, etc., can indicate vehicle parameters corresponding to an autonomous vehicle route to be traversed. Accordingly, VEEC 320 can access AVR information via AVC 310, 311, etc., to facilitate determining a corresponding virtualized route.

In an embodiment, a virtual route can correspond to a real-world route of an autonomous vehicle. As an example, a self-driving car can determine AVR information that can enable the self-driving car to navigate between an occupant's home and office. In this example, VEEC 320 can receive AVR information and can determine a virtual route based on the AVR information. In an embodiment, VEEC 320 can provide virtualized route information based on one or more of a selected virtual environment theme, selectable virtual route (SVR) information, and SVR-AVR congruence information.

In an example embodiment, system 300, in regard to AVC 310, can for example, comprise AVR information, depicted visually in FIG. 3 as AVR map 313, and a virtualized route, depicted visually again as virtualized route map 331. AVR map 313 can illustrate an autonomous vehicle route between point A and point B via point 317a. Virtualized route map 331 can illustrate a virtual route between point C and point D via point 317b. Point C can be coordinated against point A, point D can be coordinated against point B and point 317b can be coordinated against point 317a. The virtual distance along the virtual route between points C and D can be different from the physical distance along the route between points A and B. Accordingly, the apparent speed in rendered scenes for the virtualized route can be scaled accordingly, e.g., if the CD is 100 mile and AB is 10 miles, then the speed along the virtualized route can appear to occur ten times faster so that when the autonomous vehicle arrives at point B the rendered scenes of the virtualized route can appear to contemporaneously arrive at virtual point D. In other embodiments, the speed can be differently scaled, for example, progression from virtual points C to D can correlate to multiple journeys between points A and B, which scaling factors can be selected via a congruence value as has been disclosed elsewhere herein. In an example, an unplanned event at point 317a can cascade to an event at point 317b, e.g., AVP information, e.g., 116, 216, etc., can comprise real-world events at 317a that can result in updating, via VEEC 320, of the virtualized route at 317b of virtualized route map 331.

It is noted that one or more congruence values can be employed in determining a virtualized route. As an example, the compass rose 318a of AVR map 313 can indicate that the autonomous vehicle is traveling northward between points A and B. However, a sufficiently low congruence value can result in virtualized route map 331 indicating that the coordination of a virtualized route between points C and D can generally be in a virtual Easterly direction according to the compass rose 318b. In this example, the route between C and D can be selected, e.g., such as via SVR information 250, etc., and the congruence level can be selected to permit the virtual travel in a different direction than the real travel although coordination of perceived movement can still be more strongly correlated between the A to B route and the C to D route based on SVR-AVR congruence information, such as SVR-AVR congruence information 260, etc. In this example, the difference between 318a and 318b can present itself in less noticeable ways, e.g., where sunlight hits the vehicle, etc. In this example, if the trip is in the morning, then the C to D virtual route would face the rising sun in the virtual rendering of scenes, however, the actual sun would shine on the right side of the autonomous vehicle during the trip because the actual vehicle is traveling northward in the real world. However, these difference can be mitigated. As an example, if the windows of a vehicle are replaced with displays that block the real sun from shining on the occupant, then the occupant of the vehicle would not experience the actual sun during the time inside the vehicle and, accordingly, the example reduced congruence can be more irrelevant, e.g., the reduced congruence can permit the virtual and real routes to diverge (the real sun and the virtual sun can be in different places), however, where the occupant doesn't experience the actual sunlight due to the example displays blocking the sunlight, the occupant doesn't experience the discord and the divergence of the real and virtual experience can be less impactful. In this example, SVR-AVR congruence information can be applied to impact congruence between renderings of a virtualized route and a real route, however, this example also illustrates mitigating conditions.

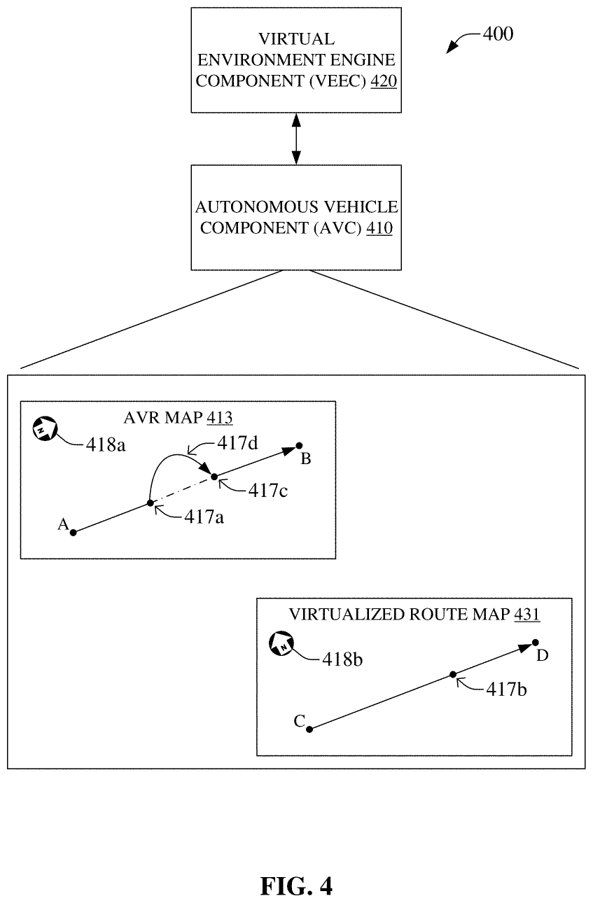

FIG. 4 is an illustration of a system 400, which can enable rendering a coordinated virtual scene that can be responsive to changes to an autonomous vehicle route, in accordance with aspects of the subject disclosure. System 400 can comprise an AVC, e.g., AVC 410, etc., that can be communicatively coupled to VEEC 420 to facilitate coordinating virtual scenes with an autonomous vehicle route. AVC 410 can determine a route for navigating an autonomous vehicle between two or more points and can facilitate access to AVR information. AVR information, e.g., AVR information 114, 214, etc., can indicate vehicle parameters corresponding to an autonomous vehicle route to be traversed. Accordingly, VEEC 420 can access AVR information via AVC 410 to facilitate determining a corresponding virtualized route.

In an embodiment, a virtual route can correspond to a real-world route of an autonomous vehicle. As an example, a self-driving car can determine AVR information that can enable the self-driving car to navigate between an occupant's home and office. In this example, VEEC 420 can receive AVR information and can determine a virtual route based on the AVR information. In an embodiment, VEEC 420 can provide virtualized route information based on one or more of a selected virtual environment theme, selectable virtual route (SVR) information, and SVR-AVR congruence information.

In an example embodiment, system 400 can comprise AVR information, depicted visually in FIG. 4 as AVR map 413, and a virtualized route, depicted visually as virtualized route map 431. AVR map 413 can illustrate an autonomous vehicle route between point A and point B via that can comprise the dot-dash line between point 417a and 417c, but not initially include the detour 417d. Virtualized route map 431 can illustrate a virtual route between point C and point D via point 417b. Point C can be coordinated against point A, point D can be coordinated against point B and point 417b can be coordinated against point 417a. In the example embodiment, the autonomous vehicle can observe an event at 417a, such as after planning a straight-line A to B route via the dashed line portion, an accident can cause rerouting of the journey via detour 417d. This information can be communicated from AVC 410 to VEEC 420, for example via autonomous vehicle performance information 116, 216, etc., enabling VEEC 420 to update the virtualized route, for example at 417b.

In the illustrated example embodiment, the update to the virtualized route at 417b can result in no change to the virtualized route despite the detour 417d in the real-world route. This can result from numerous different causes. One of these causes can be, for example, a low level of congruence indicated via SVR-AVR congruence information, which can result in the rendering of scenes illustrating a straight path in the virtual environment despite the vehicle undergoing a non-straight path in the real world. Alternatively, the detour 417d can be sufficiently gradual that the perception of the straight path in the virtual environment is determined to not be incongruous with any felt changes in inertia due to the gradual detour, e.g., the change is below an appreciable level of perception of the occupant. Additionally, vehicle systems, e.g., seat actuators, etc., can be employed to further minimize the perception of the physical detour as being incongruous with the virtualized route. The example lower level of congruence in this example can also comport with the difference in perceived direction of travel as indicated by the compasses 418a and 418b.

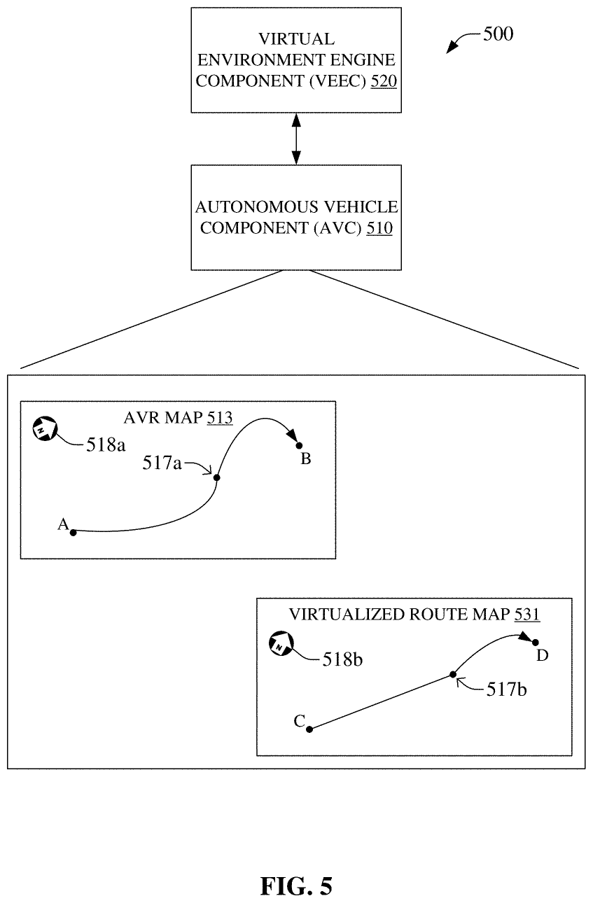

FIG. 5 is an illustration of an example system 500 that can facilitate rendering a coordinated virtual scene in a manner that is response to a selected congruence value, in accordance with aspects of the subject disclosure. System 500 can again comprise an AVC, e.g., AVC 510, etc., that can be communicatively coupled to VEEC 520 to facilitate coordinating virtual scenes with an autonomous vehicle route. AVC 510 can determine a route for navigating an autonomous vehicle between two or more points and can facilitate access to AVR information. AVR information, e.g., AVR information 114, 214, etc., can indicate vehicle parameters corresponding to an autonomous vehicle route to be traversed. Accordingly, VEEC 520 can access AVR information via AVC 510 to facilitate determining a corresponding virtualized route.

In an embodiment, a virtual route can correspond to a real-world route of an autonomous vehicle. As an example, a self-driving car can determine AVR information that can enable the self-driving car to navigate between an occupant's home and office. In this example, VEEC 520 can receive AVR information and can determine a virtual route based on the AVR information. In an embodiment, VEEC 520 can provide virtualized route information based on one or more of a selected virtual environment theme, selectable virtual route (SVR) information, and SVR-AVR congruence information.

In an example embodiment, system 500 can comprise AVR information, depicted visually in FIG. 5 as AVR map 513, and a virtualized route, depicted visually as virtualized route map 531. AVR map 513 can illustrate an autonomous vehicle route between point A and point B via point 517a. Virtualized route map 531 can illustrate a virtual route between point C and point D via point 517b. Point C can be coordinated against point A, point D can be coordinated against point B and point 517b can be coordinated against point 517a. In the example embodiment, the autonomous vehicle can travel a gentler curve between point A and point 517a, than between point 517a and point B. This autonomous vehicle route information can be communicated from AVC 510 to VEEC 520, for example via autonomous vehicle performance information 116, 216, etc., enabling VEEC 520 to determine a virtualized route, e.g., as illustrated at virtualized route map 531.

In the illustrated example embodiment, the virtualized route between virtual point C and 517b can appear straight even though it can correspond to a curved real route between point A and 517a. Moreover, the virtualized route between point 517b and D appears curved, though less so than the curve of the real-world route between point 517a and B. An explanation for why a first curved portion of a real route can result in a straight virtual route but a second curved portion of the real route can result I s curved virtual route can be an effect of SVR-AVR congruence information. In an example, a selected level of congruence, e.g., as indicated via SVR-AVR congruence information, can result in rendering of scenes based on a corresponding level of coordination between a real route and a virtualized route. In examining the real route between A and 517a, the comparatively gentler curve than between 517a and B can be gentle enough that the applied congruence level can permit a corresponding straight-line virtual segment, e.g., between C and 517b to be employed. In this example, the curve can be gentle enough that the predicted inertia of following the real curve can be determined to be subtle enough, based on the SVR-AVR congruence information, to be emulated by a straight line in the virtual route, e.g., the occupant can possibly feel the incongruity between the real and virtual route, but the selected congruence value indicates that this presentation can be acceptable to the occupant. Moreover, for the route between 517a and B, the more significant curvature of the route can exceed the example selected congruence. Accordingly, this can indicate that were the corresponding virtual route for this segment to be mapped as straight, the discrepancy between the virtual and the real route would be above the occupants indicate comfort level, e.g., exceeding the corresponding congruence value. However, the virtual route between 517b and D can be modeled as s gentle curve to reduce the difference between the real and virtual routes to below the acceptable congruence level. As such, virtualized route map 531 can illustrate that for a given congruence value, the effect of the determined virtualized route can be relative to the characteristics of the real route. It is further noted that the compasses 518a and 518b can be better aligned in system 500 than in other systems disclosed elsewhere herein, which can be due to the selected congruence value, or another selected congruence value, causing the determination of the virtualized route to conform more closely to the autonomous vehicle route, e.g., based on a selected congruence value the virtualized route can be better aligned with the compass direction of the real route.

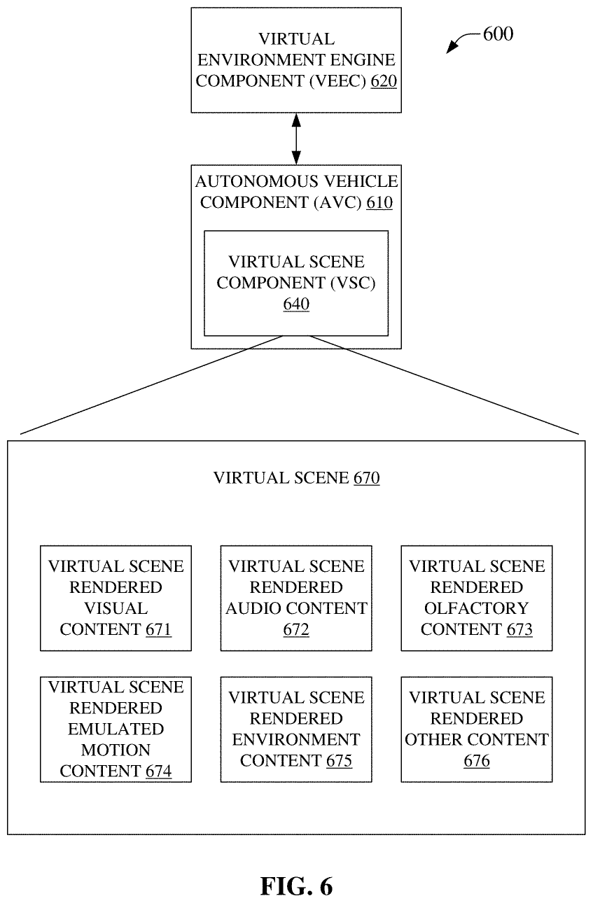

FIG. 6 is an illustration of an example system 600 that can facilitate rendering a coordinated virtual scene comprising assorted rendered sensory content, in accordance with aspects of the subject disclosure. System 600 can comprise an AVC, e.g., AVC 610, etc., that can be communicatively coupled to VEEC 620 to facilitate coordinating virtual scenes with an autonomous vehicle route. AVC 610 can determine a route for navigating an autonomous vehicle between two or more points and can facilitate access to AVR information. AVR information, e.g., AVR information 114, 214, etc., can indicate vehicle parameters corresponding to an autonomous vehicle route to be traversed. Accordingly, VEEC 620 can access AVR information via AVC 610 to facilitate determining a corresponding virtualized route.

In an embodiment, a virtual route can correspond to a real-world route of an autonomous vehicle. As an example, a self-driving car can determine AVR information that can enable the self-driving car to navigate between an occupant's home and office. In this example, VEEC 620 can receive AVR information and can determine a virtual route based on the AVR information. In an embodiment, VEEC 620 can provide virtualized route information based on one or more of a selected virtual environment theme, selectable virtual route (SVR) information, and SVR-AVR congruence information. VSC 640 can render a virtual scene, e.g., virtual scene 670, based on AVR information.

Virtual scene can comprise renderings of different content. System 600 can illustrate virtual scene 670 comprising one or more of visual, audio, olfactory, emulated motion, environmental, or other content, e.g., as virtual scene rendered visual content 671, virtual scene rendered audio content 672, virtual scene rendered olfactory content 673, virtual scene rendered emulated motion content 674, virtual scene rendered environmental content 675, virtual scene rendered other content 676, etc. Virtual scene rendered visual content 671 is easily appreciated as rendering visual content for display to an occupant, e.g., first occupant, second occupant, etc., of an autonomous vehicle, wherein the rendered visual content is for a virtual environment but corresponds to the physical movement of the autonomous vehicle in the physical world. In this regard, a selectable level of congruence, e.g., one or more congruence values as disclosed elsewhere herein, can affect how accurately the autonomous vehicle route and the virtualized route correspond.

Similarly, virtual scene rendered audio content 672 can present an audio environment to an occupant of an autonomous vehicle based on the virtual environment and the virtualized route. As an example, a virtualized route on a fictional habitable planet can include fictional animal sounds that can be present to an occupant of an autonomous vehicle, for example via a vehicle audio system, wearable audio equipment, etc. The use of rendered audio content, for example, can deepen the occupant's immersion into a virtualized route being presented, much the same way as a movie soundtrack and foley effects can alter a modern theatrical experience.

Virtual scene rendered olfactory content 673 can impart odors to the occupant. In an aspect, this can be via an autonomous vehicle's heating and cooling systems, via a wearable device, etc. As an example, where a virtual scene emulates driving through French lavender fields, introduction of compounds resulting in an odor of lavender, e.g., rendering the lavender smell, can be an appropriate part of the virtualized route being presented to the occupant.

Virtual scene rendered motion content 674 can impart motion along one or more degrees of freedom in addition to the actual motion of an autonomous vehicle traversing a route. In this regard, the rendering of motion content, for example, can provide a sensation of going over virtual cobbles even where a self-driving car is zipping along on a smooth asphalt roadway. Similarly, in another example, rendering of motion can alter a sensation of pitch, yaw, roll, etc., counter to an actual motion of an autonomous vehicle. In an aspect, motion content can be rendered via one or more actuators between the autonomous vehicle and the occupant, for example, mechanical actuators in a vehicle seat that can tip, bump, or move, the occupant in various x-y-z directions according to corresponding virtualized route information relating to a motion virtual scene.

Similarly, virtual scene rendered environmental content 675, can relate to environmental conditions, for example temperature, breezes, humidity, etc. that can be rendered to correspond, according to a selectable congruence value, to the virtualized route and the autonomous vehicle route. As an example, a virtual ride along a foggy northern Scotland seashore can be expected to have a higher humidity and lower temperature than an example real drive across a portion of Saharan Africa. Accordingly, in this example, the humidity of the autonomous vehicle cabin can be increased, and the temperature can be decreased, e.g., rendering an environmental scene. Moreover, the heating/cooling system can simulate a breeze off the virtual sea as another example environmental scene render.

Virtual scene rendered other content 676, can correspond to other types of scenes that can be rendered but are not explicitly recited for the sake of clarity and brevity but are nonetheless considered within the scope of the instant disclosure, e.g., electrostatic conditions, illumination conditions as compared to visual renderings, etc.

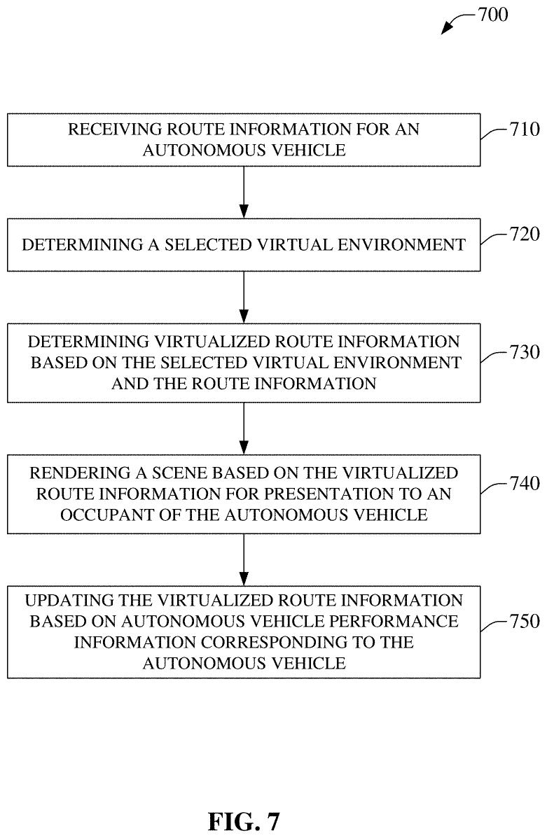

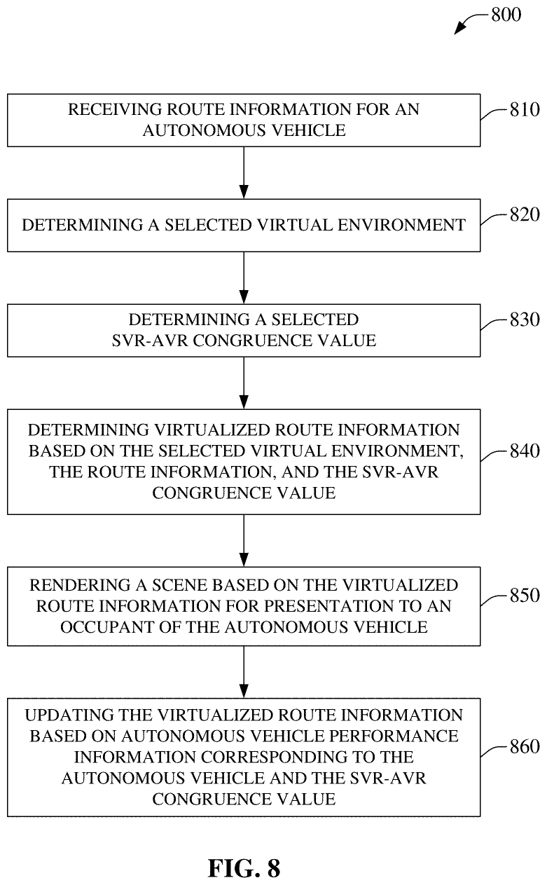

In view of the example system(s) described above, example method(s) that can be implemented in accordance with the disclosed subject matter can be better appreciated with reference to flowcharts in FIG. 7-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternately be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 7 illustrates example method 700 facilitating rendering of a coordinated virtual scene for an autonomous vehicle, in accordance with aspects of the subject disclosure. Method 700, at 710, can comprise receiving route information for an autonomous vehicle. Autonomous vehicle route information can correspond to movement of the autonomous vehicle in the real-world, e.g., a self-driving car driving from point A to point B can traverse an autonomous vehicle route between point A and point B, wherein route information can indicate characteristics, parameters, values, etc., for the autonomous vehicle route. Autonomous vehicle route information can facilitate determining a route in a virtual environment.

At 720, method 700 can comprise determining a selected virtual environment. A virtual environment can emulate a real-world environment, e.g., a non-fictional environment, an artificial environment, e.g., a fictional environment, or a combination thereof. Examples of non-fiction virtual environments can represent modern day Dallas, historic Dallas, the seafloor near the Marianas trench, airspace over Greenland, the Lunar surface, etc. Examples of fictional virtual environments can represent sci-fi movie environments, fantasy lands from famous books, etc. Further examples of mixed environments can for example add fictional roads into a real-world landscape, etc. Accordingly, artists, engineers, hobbyists, etc., can implement a nearly virtual environment they can envision, and such implemented virtual environments can be selectable to facilitate determining virtualized route in the selected environment.

Method 700, at 730, can comprise determining virtualized route information based on the selected virtual environment and the route information. The autonomous vehicle route determined for the real-world transit of an autonomous vehicle can be leveraged to determine a corresponding virtualized route in the selected virtual environment. As an example, a three-hour plane flight in an autonomous plane can correspond to a three-hour route in a selected virtual environment. In these types of examples, from the perspective of a passenger of the example flight, a piloted flight can be regarded as being via an autonomous vehicle where the pilot or a computer operating the flight is inconsequential to the experience of the passenger. Similarly, a taxi or chauffeur driven limousine can also be regarded as an autonomous vehicle that can be treated the same as another self-diving car from the perspective of a passenger, although not from the perspective of the driver.

It is noted that a virtualized route can be based on the selected virtual environment. As such, an environment of the real-world route of the autonomous vehicle can be the same as, or different from a virtual environment of the virtualized route. As an example, the real-world route can be through the corn fields of Iowa while the corresponding virtualized route can be through the fictional accretion disk of a distant black hole. In another example, the real-world route can again be through the corn fields of Iowa while the corresponding virtualized route can instead be through the canals of Venice in Italy. As a yet further example, the real-world route can still be through the corn fields of Iowa and the corresponding virtualized route can also be through the same corn fields. These examples can illustrate that there can be nearly any combination of autonomous vehicle route (AVR) and virtualized route environments.

It is further noted that a virtualized route can be based on the route information, e.g., AVR information. A virtualized route can emulate characteristics of an AVR. As an example, a left turn in an AVR can correspond to a left turn in a virtualized route. Accordingly, the AVR information can be employed in determining a virtualized route and corresponding virtualized route information. In an example, an AVR between points A and B can correspond to a virtualized route between points C and D, wherein point C can correspond to point A, and point D can correspond to point B. The expected AVR travel time from A to B can then correspond to the virtual travel time between C and D in this example. Further in this example, where a distance between A and B can be different than a virtual distance between C and D, the speed of virtual travel can be scaled so that the virtual travel from C to D can occur in a same time as the physical travel between A and B. Moreover, in embodiments of the disclosed subject matter, a degree of congruence between the AVR and the virtualized route can determine how characteristics of the AVR are represented in the virtualized route, e.g., via rendered virtualized route scenes presented to an autonomous vehicle occupant, e.g., a first occupant, second occupant, etc. As an example, a first level of congruence can result in the virtualized route emulating as many characteristics of the AVR as possible at a highest level of fidelity, e.g., a 90-degree turn in the AVR can correspond to a 90-degree turn in the virtualized route, the AVR traversing a rutted roadway can correspond to emulating a bumpy journey in the virtualized route, etc. However, other congruence(s) can be selected by an occupant. As an example, a second level of congruence can result in the virtualized route emulating few, if any, characteristics of the AVR, emulating with an arbitrary level of fidelity, etc., e.g., a 90-degree turn in the AVR can correspond to no turn at all in the virtualized route, the AVR traversing a glass-smooth roadway can correspond to emulating a bumpy journey in the virtualized route, etc. In this regard, the selection of a congruence value can correspond to tolerance of an occupant for divergence between the experienced AVR and the rendered virtualized route. As an example, a user can be highly sensitive to discord between what they see and what changes in inertia they feel, e.g., they can get motion sick when what they see poorly matches the motion they feel. In this example, a level of congruence can be selected to improve the correspondence between the AVR and the virtualized route. However, also in this example, the congruence level can be selected to still allow some discord between the AVR and the virtualized route, e.g., the congruence can be selected to be just enough to keep the occupant from getting motion sick but still allow the virtualized route to not perfectly emulate every motion characteristic of the AVR. Furthermore, more than one congruence can be selected, such that for example, a first congruence can relate to inertia, a second congruence can relate to climate, a third congruence can relate to direction of travel, a fourth congruence can relate to an audio environment, etc.

At 740, method 700 can comprise rendering a scene based on the virtualized route information for presentation to an occupant of the autonomous vehicle. Virtualized route information can comprise information enabling rendering of a scene for a virtualized route. In embodiments, rendered scenes can be strung together to provide an occupant with an experience of traversing the virtual route. In embodiments, scene(s) can be displayed to an occupant where the scene can be visually rendered. Similarly, rendering an audio scene can result in generating sounds that can be presented to an occupant of an autonomous vehicle, rendering an olfactory scene can result in releasing odors for the occupant, etc. In an example, virtualized route information can be employed to render audio, visual, and odor scenes, wherein the virtualized route corresponds to an AVR between work and home for an occupant, and wherein the virtualized route is set in a volcanic environment. In this example, motion of the autonomous vehicle can correspond to virtual motion in the virtualized route, which motion can be emulated in rendered visual scenes displayed to an occupant of the autonomous vehicle. Similarly, in this example, a distant volcanic eruption in the virtual environment can be ‘heard’ by the occupant in the autonomous vehicle by rendering the sound of the eruption via the vehicle sound system. Moreover, in this example, the vehicle heating/cooling system can emit sulfurous odors into the vehicle cabin based on rendering of an odor scene of the virtualized route. The result of the rendered visual, audio, and olfactory scenes can be that the occupant is more fully immersed in the virtualized environment comprising the virtualized route that can correspond to the AVR, e.g., the occupant can see, hear, and smell their virtual journey through the volcanic environment, and moreover, they can feel the motion of the autonomous vehicle is occurring in their traversing the virtualized route.

Method 700, at 750, can comprise updating the virtualized route information based on autonomous vehicle performance information corresponding to the autonomous vehicle. At this point, method 700 can end. In an embodiment, the updating of the virtualized route can be to maintain compliance to a level of congruence selected between the AVR and the virtualized route. An AVR can be determined and used to generate the virtualized route information, often before the autonomous vehicle beings traversing the AVR. In an example, an occupant can indicate that they want to go to the local mall upon entering a self-diving taxi. In response, an AVR between a current location and the mall can be determined. This AVR can then be employed to determine a virtualized route through a selected virtual environment. The example taxi can begin the journey to the mall along the AVR while the occupant, e.g., the passenger in this example, is presented with rendered scenes of the virtualized route that can coincide with the traversal of the AVR based on selected congruence(s). However, in this example, a tree can unexpectedly fall across a roadway of the AVR due to a windstorm that day. This can result in the example taxi detouring from the AVR to avoid the downed tree, avoid traffic resulting from the downed tree, etc. This departure from the AVR, in some embodiments, can be communicated as autonomous vehicle performance information, e.g., the change(s) in direction corresponding to the detouring by the taxi can be regarded as performance values that can be employed in updating the virtualized route information. This can enable the virtualized route information to reflect the real-world detour in the virtual route. In some embodiments, the detour can result in generating new AVR that can spawn a new virtualized route, e.g., a new virtualized route can be followed from where the taxi leaves the previous AVR at the start of the detour.

FIG. 8 illustrates example method 800, enabling rendering of a coordinated virtual scene based on a selectable congruence value, in accordance with aspects of the subject disclosure. Method 800, at 810, can comprise receiving route information for an autonomous vehicle. Autonomous vehicle route information can correspond to movement of the autonomous vehicle in the real-world. Autonomous vehicle route information can facilitate determining a route in a virtual environment.

At 820, method 800 can comprise determining a selected virtual environment. A virtual environment can emulate a real-world environment, a fictional environment, or a combination thereof. Implemented virtual environments can be selectable to facilitate determining virtualized route in the selected environment.

Method 800, at 830, can comprise determining a selected SVR-AVR congruence value. A degree of congruence between an AVR and a virtualized route can be indicated via a selectable SVR-AVR congruence value. More than one SVR-AVR congruence value can be selected, such that for example, a first congruence can relate to inertia, a second congruence can relate to climate, a third congruence can relate to direction of travel, a fourth congruence can relate to an audio environment, etc. In example embodiments, a SVR-AVR congruence value can determine how characteristics of an AVR are represented in a virtualized route. As examples, a first level of congruence can result in the virtualized route emulating as many characteristics of the AVR as possible at a highest level of fidelity; a second level of congruence can result in the virtualized route emulating few, if any, characteristics of the AVR, emulating with an arbitrary level of fidelity, etc.; and a third level of congruence can perform a moderate level of coordination between the AVR and the virtualized environment; etc. In this regard, the selection of a SVR-AVR congruence value can correspond to a tolerance, preference, etc., of an occupant for divergence between the experienced AVR and the rendered virtualized route, e.g., what an occupant physically experiences in a real environment can be represented in a virtual environment at one or more selectable levels of congruence, which can make the virtual experience more palatable to an occupant. In some embodiments, SVR-AVR congruence value(s) can be stored in a profile and can be retrieved therefrom to facilitate determining the virtualized route at the selected congruence(s).

At 840, method 800 can comprise determining virtualized route information based on the selected virtual environment, the route information, and the SVR-AVR congruence value. An autonomous vehicle route can be employed to determine a corresponding virtualized route in the selected virtual environment. The relationship between the virtual and the real routes can be influenced, dictated, controlled, etc., in part, by the SVR-AVR congruence value. A virtualized route can be based on the selected virtual environment and can be more or less coherent with the real route in accord with a selected SVR-AVR congruence value. As such, an environment of a real-world route of an autonomous vehicle can be the same as, or different from a virtual environment of the virtualized route, both in terms of the rendered scenes representing the actual real route, another real route, a fictional route, etc., and in terms of how tightly coupled the characteristics of the real route are to the virtualized route due to the selected congruence(s). Nearly any combination of AVR and virtualized route environment can occur and be subject to one or more SVR-AVR congruence value(s) selected to govern the correspondence between the real and the virtual experiences. As such, a virtualized route can be said to emulate, at the designated congruence(s), characteristic(s) of an AVR.

At 850, method 800 can comprise rendering a scene based on the virtualized route information for presentation to an occupant of the autonomous vehicle. Virtualized route information can comprise information enabling rendering of a scene for a virtualized route. In embodiments, rendered scenes can be strung together to provide an occupant with an experience of traversing the virtual route. In embodiments, rendered visual scene(s) can be displayed to an occupant. Audio, olfactory, environmental, and other types of scenes can similarly be rendered. As such, an example occupant of an autonomous vehicle can see, hear, smell, feel, etc., their virtual journey based on the environment of the autonomous vehicle, the real route, the virtual route, and the selected level of congruence.

At 860, method 800 can comprise updating the virtualized route information based on autonomous vehicle performance information corresponding to the autonomous vehicle and the SVR-AVR congruence value. At this point, method 800 can end. The updating of the virtualized route can be to maintain a level of congruence selected between the AVR and the virtualized route. As previously noted, an AVR can be determined and used to generate the virtualized route information in accord with an SVR-AVR congruence value. This can occur before the autonomous vehicle actually begins traversing the AVR. Changes to the environment of the autonomous vehicle, autonomous vehicle route, or to the autonomous vehicle itself can be reflected in autonomous vehicle performance information and, as such, can be employed to update the virtualized route information, to generate new virtualized route information, etc. Typically, autonomous vehicle performance information can represent more real-time updates of the AVR and, correspondingly and in accord with the SVR-AVR congruence value, the virtualized route information. This can enable the virtualized route information to reflect the real-world in the virtual route, and more particularly real-time changes in the real-world can correspond to changes in the virtual route.

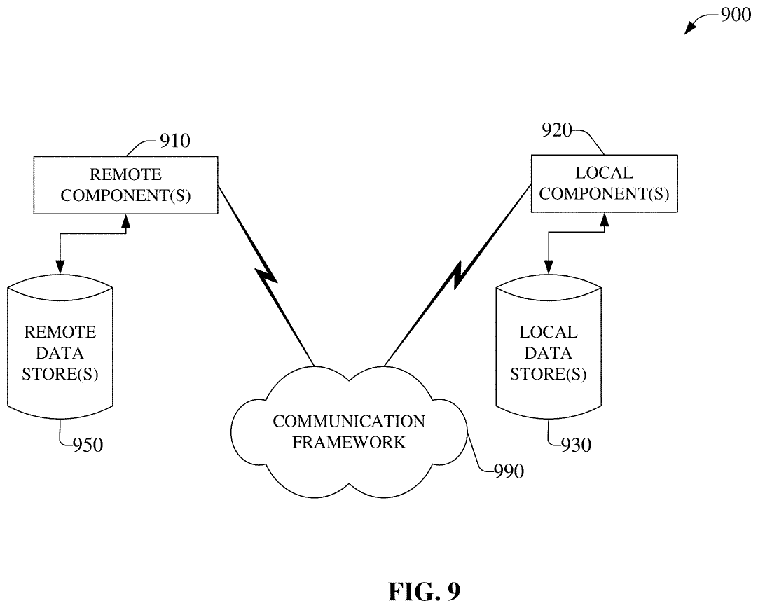

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can comprise VEEC 120, 220, 320, 420, 520, 620, etc., AVCs, e.g., 110, 210, 310, 311, 410, 510, 610, etc., or other components supporting the technology(s) disclosed herein.

The system 900 also comprises one or more local component(s) 920. The local component(s) 920 can be hardware and/or software (e.g., threads, processes, computing devices). In some embodiments, local component(s) 920 can comprise VEEC 120, 220, 320, 420, 520, 620, etc., AVCs, e.g., 110, 210, 310, 311, 410, 510, 610, etc., or other components supporting the technology(s) disclosed herein.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. As an example, AVC 110, 210, 310, 311, 410, 510, 610, etc., can locally generate an AVR information 114, 214, etc., that can be communicated to VEEC 120, 220, 320 420, 520, 620, etc., or other remotely located components, via communication framework 190, 990, etc., or other communication framework equipment, to facilitate determining virtualized route information 130, 230, etc. Remote component(s) 910 can be operably connected to one or more remote data store(s) 950, such as a hard drive, solid state drive, SIM card, device memory, etc., that can be employed to store information on the remote component(s) 910 side of communication framework 990.

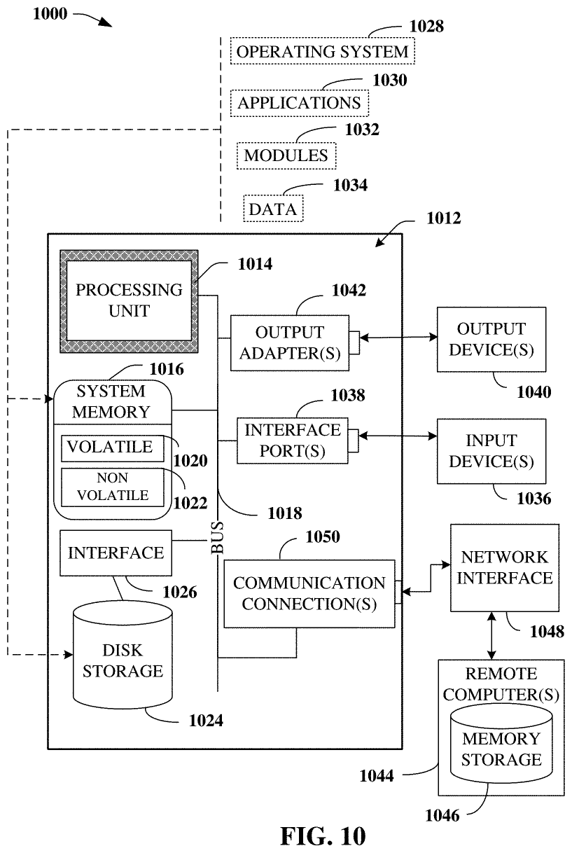

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), single board computers, microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, comprised in VEEC 120, 220, 320, 420, 520, 620, etc., AVCs, e.g., 110, 210, 310, 311, 410, 510, 610, etc., or other components supporting the technology(s) disclosed herein, can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, can cause a system comprising a processor to perform operations comprising determining a first route intended to be traveled by an autonomous vehicle and determining a first virtual route based on the first route, a virtual environment, and a congruence value. A virtual scene of the virtual route can be rendered, wherein the virtual scene of the virtual route corresponds to a point along the first route traversed by the autonomous vehicle. Moreover, the virtual route can be updated based on a contemporaneous change to the traversal of the first route by the autonomous vehicle. The update can accord with the congruence value.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command-line controlled interface, etc., allowing a user to interact with computer 1012. Input devices 1036 comprise, but are not limited to, a pointing device such as a mouse, trackball, stylus, touch pad, keyboard, microphone or other human voice sensor, accelerometer, biometric sensor, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial bus port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted elsewhere herein, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “eNodeB,” “home Node B,” “home access point,” “5G network radio,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can comprise packetized or frame-based flows. Data or signal information exchange can comprise technology, such as, single user (SU) multiple-input and multiple-output (MIMO) (SU MIMO) radio(s), multiple user (MU) MIMO (MU MIMO) radio(s), long-term evolution (LTE), LTE time-division duplexing (TDD), global system for mobile communications (GSM), GSM EDGE Radio Access Network (GERAN), Wi Fi, WLAN, WiMax, CDMA2000, LTE new radio-access technology (LTE-NX), massive MIMO systems, etc.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio access network. Authentication can refer to authenticating a user-identity to a user-account. Authentication can, in some embodiments, refer to determining whether a user-identity requesting a service from a telecom network is authorized to do so within the network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to as extremely high frequency (EHF) waves. The wavelength (λ) for millimeter waves is typically in the 1-mm to 10-mm range.

The term “infer” or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A device, comprising:
a processor; and
a memory that stores executable instructions that, when executed by the processor, facilitate performance of operations comprising:
receiving an indication of a first route destined to be traveled by an autonomous vehicle;
determining a first virtual route based on the first route and a selectable virtual environment;
rendering a virtual scene of the virtual route, wherein the rendering corresponds to a point along the first route traversed by the autonomous vehicle; and
updating the virtual route based on a contemporaneous change to traversal of the first route by the autonomous vehicle.

2. The device of claim 1, wherein the device is located remotely from the autonomous vehicle.

3. The device of claim 1, wherein the autonomous vehicle comprises the device.

4. The device of claim 1, wherein the contemporaneous change is a change in a speed of the autonomous vehicle.

5. The device of claim 1, wherein the contemporaneous change is a departure of the autonomous vehicle from the first route.

6. The device of claim 1, wherein the contemporaneous change is a return of the autonomous vehicle to the first route.

7. The device of claim 1, wherein the selectable virtual environment models a real physical environment.

8. The device of claim 7, wherein the first route is able to be physically traversed by the autonomous vehicle in the real physical environment.

9. The device of claim 7, wherein the first virtual route is not able to be physically traversed by the autonomous vehicle in the real physical environment according to a physical law in the real physical environment.

10. The device of claim 1, wherein the selectable virtual environment models a fictional environment.

11. The device of claim 1, wherein the first virtual route is designed to correspond to motion physics of traversing the first route while being set in the selectable virtual environment.

12. The device of claim 1, wherein rendering the virtual scene results in an occupant of the autonomous vehicle experiencing the virtual scene as the autonomous vehicle traverses the first route.

13. The device of claim 1, wherein permission to select the selectable virtual environment is based on determining that a rule selected from a group of rules has been satisfied, and wherein the group of rules comprise a payment model rule, an age restriction rule, a health protection rule, and a governmental regulation rule.

14. A method, comprising:
receiving, by a system comprising a processor, an indication of a first route intended to be traveled by an autonomous vehicle;
determining, by the system, a first virtual route based on the first route, a virtual environment, and a congruence value; and
rendering, by the system, a virtual scene of the virtual route, wherein the virtual scene relates to a portion of the first route.

15. The method of claim 14, wherein the determining the first virtual route is based on the first route, a selectable virtual environment, and a selectable congruence value, wherein the selectable virtual environment is selected by an occupant of the autonomous vehicle, and wherein the selectable congruence value is selected by the occupant of the autonomous vehicle.

16. The method of claim 15, wherein selecting the selectable virtual environment by the occupant of the autonomous vehicle is permitted where a selection rule is determined, by the system, to be satisfied.

17. The method of claim 15, wherein the occupant of the autonomous vehicle is a passenger in the autonomous vehicle, and wherein the autonomous vehicle is able to be operated by a human operator other than the passenger.

18. A non-transitory machine-readable medium, comprising executable instructions that, when executed by a processor of equipment, facilitates performance of operations, comprising:
determining a first route intended to be traveled by an autonomous vehicle;
determining a first virtual route based on the first route, a virtual environment, and a congruence value;
rendering a virtual scene of the virtual route, wherein the virtual scene of the virtual route corresponds to a point along the first route traversed by the autonomous vehicle; and
updating the virtual route based on a concurrent change to a travel path via the first route by the autonomous vehicle, wherein the updating accords with the congruence value.

19. The non-transitory machine-readable medium of claim 18, wherein the virtual environment is selected by an occupant of the autonomous vehicle, and wherein the congruence value is selected by the occupant of the autonomous vehicle.

20. The non-transitory machine-readable medium of claim 18, wherein the autonomous vehicle is operated by an entity other than the occupant of the autonomous vehicle.
